(19) United States
(12) Patent Application Publication
(10) Pub. No.: US 2021/0008745 A1
(43) Pub. Date: Jan. 14, 2021

(54) SAFETY RAZOR SHAVING SYSTEM

(71) Applicant: BEIERSDORF AKTIENGESELLSCHAFT, Hamburg (DE)

(72) Inventors: Alexander KRUEMKE, Hamburg (DE); Peter MAURER, Neumuenster (DE); Michaela KOHUT, Hamburg (DE); Frank HETZEL, Welle (DE); Jelte STEUR, Oudehaske (NL); Arif VEENDIJK, Assen (NL); Johannes Rogier DE VRIND, Haren (NL); Patje SANDER, Groningen (NL)

(21) Appl. No.: 16/979,982

(22) PCT Filed: Dec. 18, 2018
(86) PCT No.: PCT/EP2018/085376

§ 371 Date: Sep. 11, 2020

(30) Foreign Application Priority Data
Mar. 13, 2018 (DE) 10 2018 105 821.7

(51) Int. Cl. B26B 21/52; B26B 21/22; B26B 21/40

(52) U.S. Cl. CPC B26B 21/521; B26B 21/4025; B26B 21/4018; B26B 21/225

(57) ABSTRACT

A safety razor shaving system comprises: a handle having a handle connecting structure; and a replaceable razor cartridge having a cartridge connecting structure; wherein the handle connecting structure and the cartridge connecting structure are configured to be brought together along a connection axis into a securely connected position; and wherein the handle connecting structure or the cartridge connecting structure has an L-shaped release member including a leg that extends along the connection axis and a foot that extends away from the connection axis, the L-shaped release member configured to release the handle connecting structure and the cartridge connecting structure from the securely connected position in response to a user-applied force to the foot.

### FIELD

The invention relates to safety shaving razor systems and, more particularly, to structures for connecting a replaceable blade cartridge to a handle of such safety razor shaving systems.

### BACKGROUND

Safety razor shaving systems typically comprise a handle and a replaceable blade cartridge (often also called a disposable cartridge or simply a cartridge) in which a plurality of blades are arranged in parallel between a guard and a cap, with a connecting structure (or connecting structures) for releasably securing the cartridge to the handle, release of the cartridge from the handle being effected by a user-actuated mechanism such as a button on the handle. Often, connecting structures and release mechanisms have a relatively bulky construction. It would therefore be desirable to provide a shaving razor system with a relatively compact connecting structure and release mechanism.

### SUMMARY

One embodiment provides a safety razor shaving system, comprising: a handle having a handle connecting structure; and a replaceable razor cartridge having a cartridge connecting structure; wherein the handle connecting structure and the cartridge connecting structure are configured to be brought together along a connection axis into a securely connected position; and wherein the handle connecting structure or the cartridge connecting structure has an L-shaped release member including a leg that extends along the connection axis and a foot that extends away from the connection axis, the L-shaped release member configured to release the handle connecting structure and the cartridge connecting structure from the securely connected position in response to a user-applied force to the foot.

The L-shaped design of the release member is simple and has a compact form factor that allows it to fit into a relatively small ‘neck’ area between the main body of the handle and the upper part of the cartridge, yet still enables the user to easily actuate the release member.

The term “along the connection axis” includes configurations which are parallel to the connection axis as well as configurations which are offset from parallel. Similarly, the term “away from the connection axis” includes configurations which are perpendicular to the connection axis as well as configurations which are offset from perpendicular. Thus, the L-shaped release member can be approximately L-shaped, i.e., the leg and the foot do not have to be exactly at right angles to one another. The foot can extend upwardly away from the connection axis.

In one embodiment, the handle connecting structure and the cartridge connecting structure have complementary securing elements, one of which is formed on the leg of the L-shaped release member. The other securing element can be formed on the handle connecting structure or the cartridge connecting structure depending on whether the L-shaped release member is provided on the cartridge connecting structure or the handle connecting structure, respectively. Alternatively, the complementary securing elements can be formed on the handle connecting structure and the cartridge connecting structure. The securing elements can utilize mechanical means (e.g., complementary projections, a projection and a complementary groove or hole), magnetic means (e.g., a magnet and corresponding ferrous metal), combinations thereof, or the like, to secure the connecting structures together.

In one embodiment, the L-shaped release member includes a pair of the legs having respective securing elements configured to releasably engage one or more complementary securing elements of the other connecting structure. This provides a secure engagement between handle connecting structures.

In one embodiment, the L-shaped release member is configured to pivot about a pivot axis located: at an intersection of the leg and the foot; at a free end of the leg; or between the free end of the leg and the intersection of the leg and the foot. Such a release member permits easy user actuation without extending the form factor since the movement (pivoting) is perpendicular to the connection axis. However, in another embodiment the L-shaped release member is configured to be movable along the connection axis.

In one embodiment, the L-shaped release member is integrally formed with a housing of the cartridge connecting structure, and the leg is configured to resiliently deform when the user-applied force is applied to the foot. This provides a simple design having a reduced number of (moving) parts.

In one embodiment, the cartridge connecting structure comprises a housing with a closed end and an open end, the open end configured to receive the handle connecting structure, at least a portion of the closed end located within a cavity of the replaceable blade cartridge. This can provide in a small ‘neck’ area defined between the gripping portion of the handle and the main body of the replaceable blade cartridge. A pivoting structure can be provided at the closed end of the housing, the pivoting structure located within the cavity and of the replaceable razor cartridge and configured to allow the replaceable razor cartridge to pivot. As such, the pivoting structure does not increase the size of ‘neck’ area so that the compact form factor is retained.

One embodiment of the present invention provides a replaceable razor cartridge for a safety razor shaving system including a handle having a handle connecting structure, comprising: a guard, a cap, and one or more blades disposed in parallel between the guard and the cap; and a cartridge connecting structure configured to be brought together with the handle connecting structure along a connection axis into a securely connected position; wherein the cartridge connecting structure has an L-shaped release member including a leg that extends along the connection axis and a foot that extends away from the connection axis, the L-shaped release member configured to release the handle connecting structure and the cartridge connecting structure from the securely connected position in response to a user-applied force to the foot.

One embodiment of the present invention provides a handle for a safety razor shaving system including a replaceable razor cartridge having a cartridge connecting structure, comprising: a body configured to be gripped by a user; and a handle connecting structure extending from the body, the handle connecting structure configured to be brought together with the cartridge connecting structure along a connection axis into a securely connected position; wherein the handle connecting structure) has an L-shaped release member including a leg that extends along the connection axis and a foot that extends away from the connection axis, the L-shaped release member configured to release the handle connecting structure and the cartridge connecting structure from the securely connected position in response to a user-applied force to the foot.

In any of the aforementioned safety razor system embodiments, the handle can comprise an underneath surface portion facing the skin of the user in use; a front surface portion facing in the opposite direction from the shaving direction in use; a rear surface portion facing in the shaving direction in use; a top surface portion and side surface portions, one directed to either side of the blade length in use; wherein the top surface portion, underneath surface portion and side surface portions together form a continuous smooth surface which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

The “chunky” bulbous shapes of the handle allow a particularly flexible ergonomic handling, giving many varied gripping positions for the human hand and easy twisting of the handle within the grip to reach different angles. The handle can alternatively be defined in terms of its bulbous shape, as comprising a handle body and a handle connecting structure; wherein the handle body is bulbous in two orthogonal directions, widening away from an end surface towards the centre of the body. This definition applies to any of the aforementioned safety razor system embodiments.

Moreover this handle shape allows the handle to stand on a surface with the blade and any lubrapad of an attached blade unit suspended above the surface. This can help prevent blade corrosion. The handle can alternatively be defined in these terms as comprising a handle body with a substantially flat end surface and a side surface (to which the handle connecting structure is attached), wherein: when the flat end surface is in contact with a horizontal plane and the cartridge is connected to the handle via the cartridge connecting structure and the handle connecting structure, the safety razor is in a stable position of rest, the flat end surface forming the safety razor's only region of contact with the plane and elevating the cartridge above the plane. This definition applies to any of the aforementioned safety razor system embodiments.

These and other features and advantages will be apparent from a reading of the following detailed description and a review of the associated drawings. It is to be understood that both the foregoing general description and the following detailed description are explanatory only and are not restrictive of the invention as claimed.

### DESCRIPTION OF FIGURES

Embodiments will now be described by way of example with reference to the accompanying drawings in which:

FIG. 1 is perspective view of a safety razor shaving system, in accordance with an embodiment of the present invention.

FIG. 2 is a perspective view of the cartridge and part of the handle of the safety razor shaving system shown in FIG. 1, showing the handle connecting structure disconnected from the cartridge connecting structure.

FIG. 3 is a perspective view of part of the handle and the cartridge of the safety razor shaving system shown in FIG. 1, showing the handle connecting structure connected to the cartridge connecting structure.

FIG. 4 is a cross-sectional side view of the part of the handle and the cartridge shown in FIG. 3.

FIG. 5 is perspective view of a safety razor shaving system, in accordance with another embodiment of the present invention.

FIG. 6 is a perspective view of the cartridge and part of the handle of the safety razor shaving system shown in FIG. 5, showing the handle connecting structure disconnected from the cartridge connecting structure.

FIG. 7 is a perspective view of part of the handle and the cartridge of the safety razor shaving system shown in FIG. 5, showing the handle connecting structure connected to the cartridge connecting structure.

FIG. 8 is a cross-sectional side view of the part of the handle and the cartridge shown in FIG. 7.

FIG. 9 schematically illustrates cross-sectional side views of handle connecting structures and cartridge connecting structures, in accordance with other embodiments of the present invention.

FIG. 10 is perspective view of a safety razor shaving system, in accordance with another embodiment of the present invention.

FIG. 11 is perspective view of a safety razor shaving system, in accordance with another embodiment of the present invention.

FIGS. 12 to 14 are perspective views of the handle of the safety razor shaving systems shown in FIGS. 10 and 11.

### DETAILED DESCRIPTION

This disclosure is generally concerned with connecting structures and release mechanisms that allow a replaceable blade cartridge to be connected and disconnected from a handle of a safety razor shaving system. As such, certain features of the replaceable blade cartridge, such as the blades, are not depicted in the figures. It will be appreciated, however, that these features form part of the safety razor shaving system described herein.

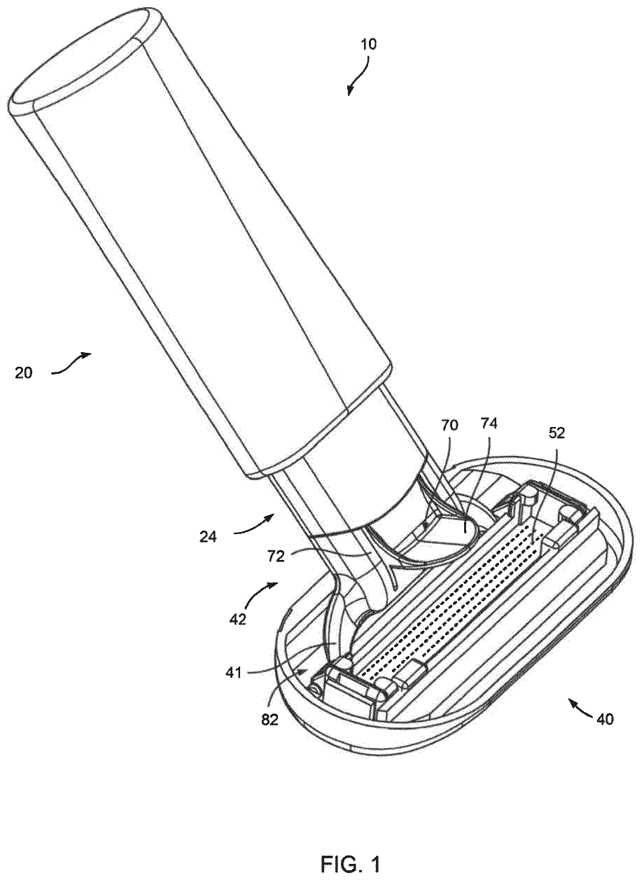

FIGS. 1 to 4 show a safety razor system 10 comprising a handle 20 and a replaceable blade cartridge 40.

The handle 20 has a handle connecting structure 24 shaped like a rectangular cuboid or block with an upper surface 26, a lower surface 27, two lateral surface 28 (that define the width of the handle connecting structure 24), and a front surface 29. The terms “upper” and “lower” are used to define the surface of the handle connecting structure 24 relative to the shaving surface. That is, when the handle 20 is connected to the replaceable blade cartridge 40 and drawn across the skin during shaving, the lower surface 27 generally will be facing the surface being shaved and the upper surface 26 generally will be facing away from the surface being shaved. The upper surface 26 has a cut-out portion 30 that extends between the lateral surface 28 and from the front surface 29 to a ridge 31, curving as it approaches the ridge 31. On the opposite side of the ridge 31, another cut-out portion 32 extends between the side surfaces 26. The ridge 25 serves as a complementary securing element to a securing element of the cartridge connecting structure 42, as will be describer later.

The cartridge 40 has a guard 44, a cap 48, and one or more elongate blades disposed in parallel between the guard 44 and the cap 48. For example, the cartridge 40 can have two or more (for example, five) blades. A shaving aid, such as a lubricating strip, can be incorporated in one or both of the guard 44 and the cap 48. As noted above, certain features of the cartridge 40, such as the blades, are not depicted in the figures. However, the dashed lines in the figures represent the cutting edge positions of the blades. The upper portion of the cartridge is also not depicted in FIGS. 1 to 4. The expressions “in front of” and “to the rear of” the blades are used in relation to the shaving direction. That is, when the safety razor shaving system 10 is drawn across the skin in the shaving direction, the guard 44 is ahead of the blades in the shaving direction and the cap 48 is behind the blades in the shaving direction. The guard 44 and the cap 48 are connected by lateral side portions 50.

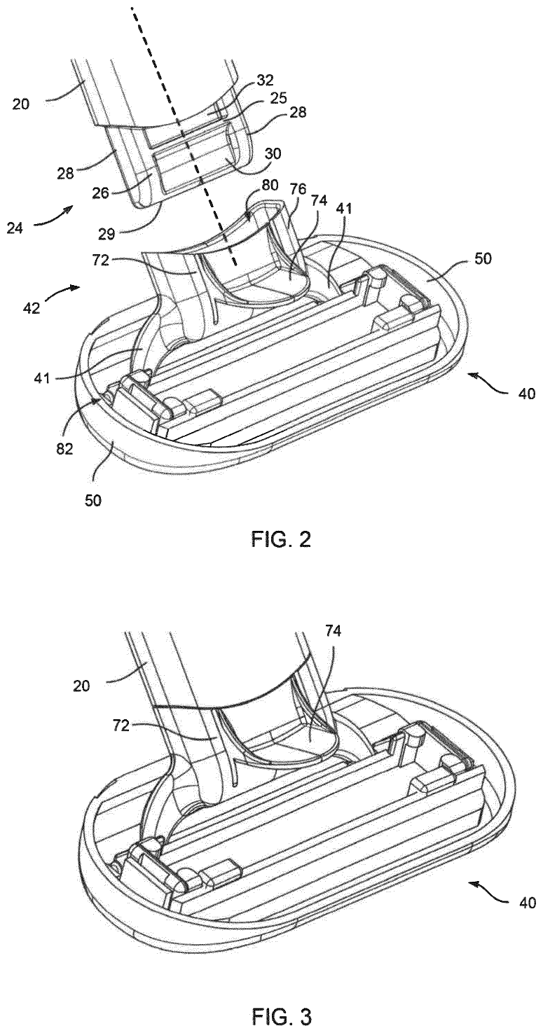

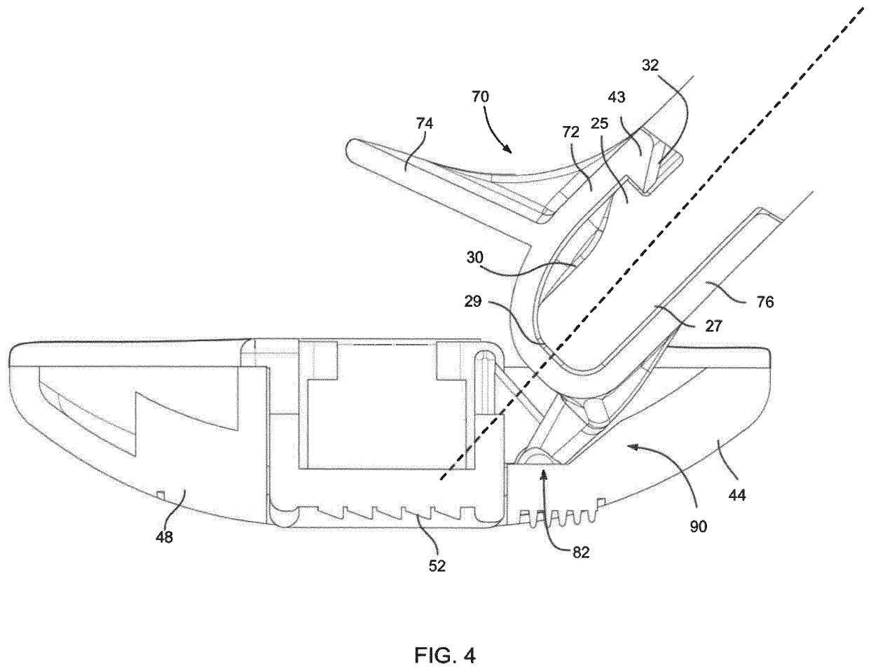

The cartridge 40 also has a cartridge connecting structure 42 in the form of a housing 76 with an interior shaped to receive the handle connecting structure 24. In this case, the rectangular cuboid or block shaped handle connecting structure 42 is configured to fit completely inside the housing 76. The front surface 29 of the handle connecting structure 24 is rounded to permit easier insertion into the housing 76 of the cartridge connecting structure 42. The interior upper surface of the housing is provided with a securing element in the form of a hook 43 that is configured to engage with the ridge 25 of the handle connecting structure 24. As the handle connecting structure 24 is inserted into the cartridge connecting structure 42 along a connection axis (shown as a dashed line in FIGS. 2 and 4), the lower and lateral surfaces 27, 28 of the handle connecting structure 24 guide it into the housing 76. As the handle connecting structure 24 is further inserted into the cartridge connecting structure 42, the hook 43 of the cartridge connecting structure 24 is resiliently urged upwards by the curved surface of the cut-out portion 30 of the handle connecting structure 42, until the hook 43 crosses the ridge 25 and comes to rest in the shallow cut-out portion 32 on the other side (to the rear) of the ridge 25. The rear of the ridge 25 is formed as a wall that engages the hook 43 to securely hold the handle and cartridge connecting structures 24,42 together. One or more hooks 43 of different widths can be provided.

To enable the hook(s) 43 to disengage from the ridge, the cartridge connecting structure 24 is provided with an L-shaped release member 70 with a leg 72 that extends along the connection axis and a foot 74 that extends away from the connection axis. As shown in FIG. 4, the leg 72 of the L-shaped release member 70 is integrally formed as part of the upper surface of the housing 76 with the hook 43 at its end. The foot 74 is formed as a tab-shaped element having a thin side profile and can be actuated by the user with finger or thumb. Specifically, when a force is applied to the foot 74 in the direction of the cartridge, the leg 72 to resiliently deform so that the hook 43 disengages from the ridge 25, thereby allowing the handle connecting structure 24 to be withdrawn from the cartridge connecting structure 42. Thus, the housing 76 is preferably made of resiliently deformable plastic. Buttress-like portions are provided on either sides of the tab shaped element, not only to provide added strength to the foot 74 against the user-applied force but also to aid in pulling the leg 72 and hook 43 upwards.

The cartridge connecting structure 42 has two pivot arms 41 that extend from the housing 76 and which have respective outwardly extending pins (not shown) that are housed in recesses or holes provided in the replaceable razor cartridge 40 to allow pivoting of the replaceable razor cartridge 40 relative to the handle 20. These can be implemented in a known manner.

While the handle connecting structure 24 described above has just one securing element, it will apparent that other types of securing elements (and indeed more than one) can be provided. Furthermore, the configurations of the handle and cartridge connecting structures can be reversed. For example, the handle connecting structure can be formed as a housing, with the cartridge connecting structure formed as a generally rectangular cuboid shape described above. The L-shaped release member can be provided so that the foot and hook are located at the opening of the housing. Then, instead of applying a force towards the cartridge, the user can apply a force away from the cartridge to release the hook from the ridge.

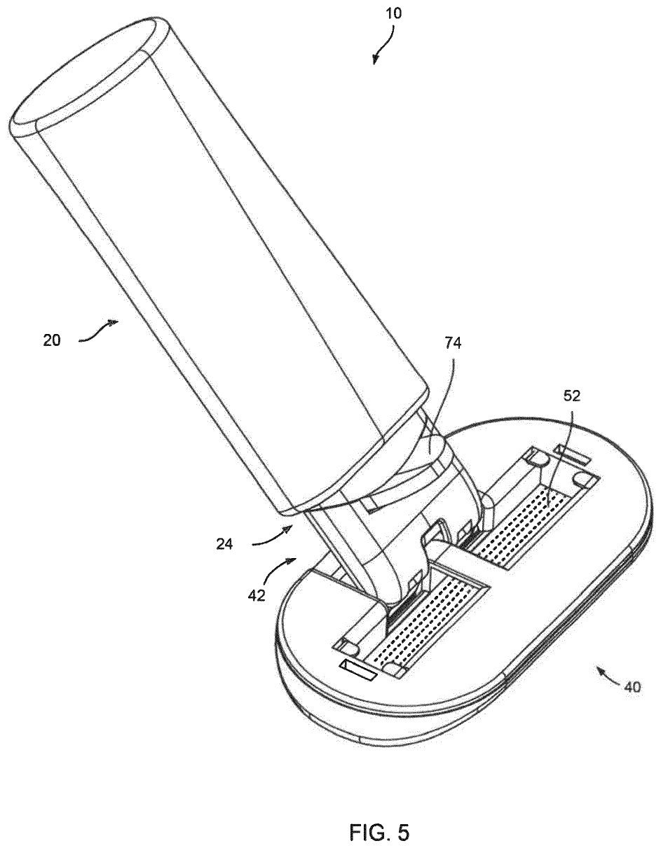

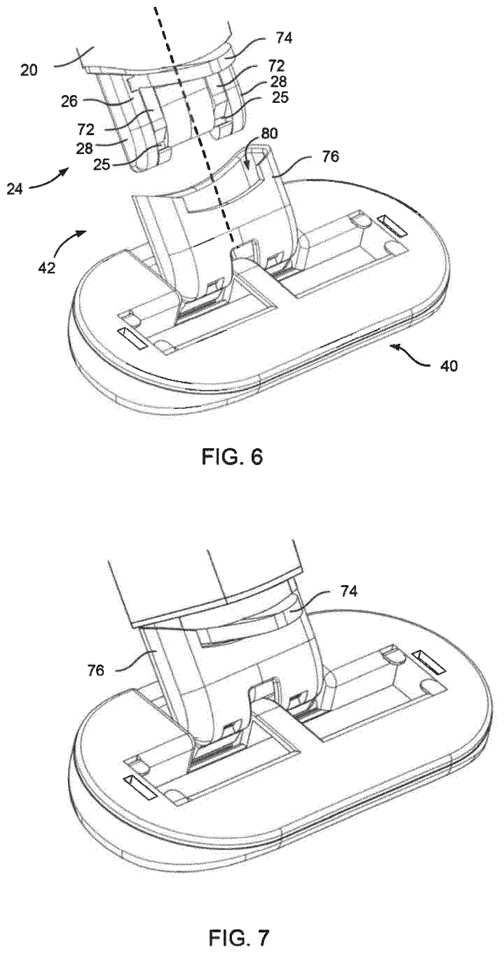

FIGS. 5 to 8 show another safety razor system 10. In many respects, the safety razor system 10 depicted in these figures may be similar to that described above with reference to FIGS. 1 to 4, so that certain features will not be described in relation to the safety razor system 10 depicted in FIGS. 5 to 8. It will be appreciated that these features may function in the manner as described above (unless otherwise indicated below) and are hereby incorporated into this additional configuration. Like structures and/or components may be given like reference numerals.

In particular, the safety razor system 10 depicted in FIGS. 5 to 8 comprises a handle 20 having a handle connecting structure 24, and a replaceable blade cartridge 40 having a guard 44, a cap 48, one or more elongated blades (not depicted) disposed in parallel between the guard 44 and the cap 48, and a cartridge connecting structure 42. A shaving aid, such as a lubricating strip, can be incorporated in one or both of the guard 44 and the cap 48. The handle connecting structure 24 is formed as a stub end of the handle 20 and shaped like a rectangular cuboid or block with an upper surface 26, a lower surface 27, two lateral surface 28 (that define the width of the handle connecting structure 24), and a front surface 29. Likewise, the cartridge connecting structure 42 is in the form of a housing 76 with an interior shaped to receive the handle connecting structure 24.

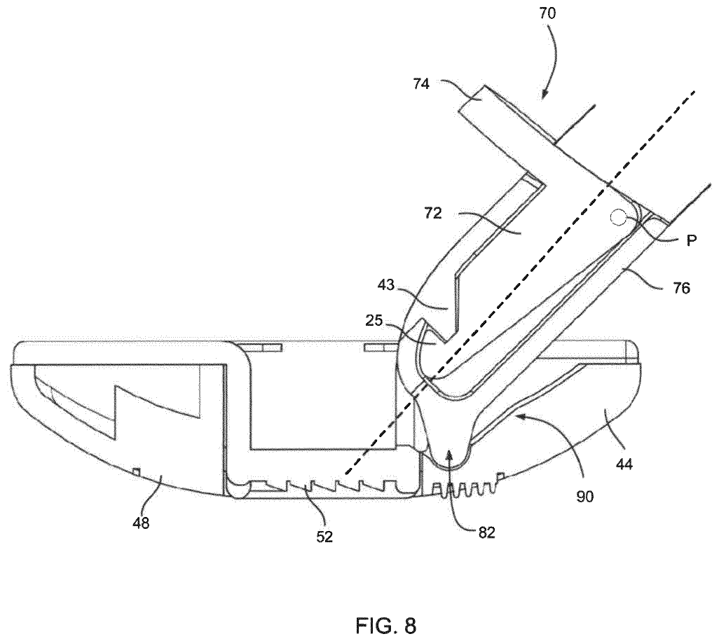

However, the L-shaped release member 70 of the safety razor system 10 depicted in FIGS. 5 to 8 forms part of the handle connecting structure 24 and is based on a pivoting design. The release mechanism has two legs 72 that extend along the connection axis (shown as a dashed line) and a foot 74 that extends away from the connection axis. The free ends of the legs 72 are provided with securing elements 25 in the form of hook elements (one on each leg). These are configured to engage complementary securing elements 43 of the cartridge connecting structure 42, here formed as one or more catch elements on the inner upper surface of the housing 76, when the handle connecting structure 24 is inserted into the housing 76. Specifically, when the handle connecting structure 24 is inserted into the cartridge connecting structure 42 along the connection axis, the leading portion of the hook elements 24 meet the inclined surfaces of the catch element(s) 43. As the handle connecting structure 24 is further inserted into the cartridge connecting structure 42, the L-shaped release member 70 pivots about a pivot axis (denoted ‘P’ in FIG. 8) at a joint between the foot 74 and the legs 72, thereby allowing the hook elements 25 to ‘ride’ over the catch element(s) 43. The rear of the catch element(s) 43 is formed as a wall that engages the hook element 35 to securely hold the handle and cartridge connecting structures 24, 42 together. The L-shaped release member 70 can be maintained in this secured position by biasing means, such as a spring, included in the handle connecting structure (not shown).

The foot 74 of the L-shaped release member 70 is, as before, formed as a tab-shaped element that has a thin side profile and that can be actuated by the user with finger or thumb. However, when a force is applied to the foot 74 in the direction of the cartridge 40, the legs 72 pivot downwards and thereby disengage the hook elements 25 from the catch element(s) 43, allowing the handle connecting structure 24 to be withdrawn from the cartridge connecting structure 42.

The L-shaped release member 70 shown in FIGS. 5 to 8 has two legs 72, which provides a good balance between the number of components and secure engagement between the connecting structures 24, 42. But alternatively a single leg or more than two legs can be provided. These can be of equal or different (e.g., larger) size compared to those shown in FIGS. 5 to 8.

Like the safety razor system 10 depicted in FIGS. 1 to 4, the housing 76 of the cartridge connecting structure 42 shown in FIGS. 5 to 8 has a pivoting mechanism to allow pivoting of the replaceable razor cartridge 40 relative to the handle 20. However, here the pivoting mechanism is provided entirely in a cavity 90 of the cartridge 40 (though it will be appreciated that the pivoting mechanism can include pivot arms like those shown in FIGS. 1 to 4 that are outside cavity 90). The pivoting mechanism itself can be implemented in a known manner.

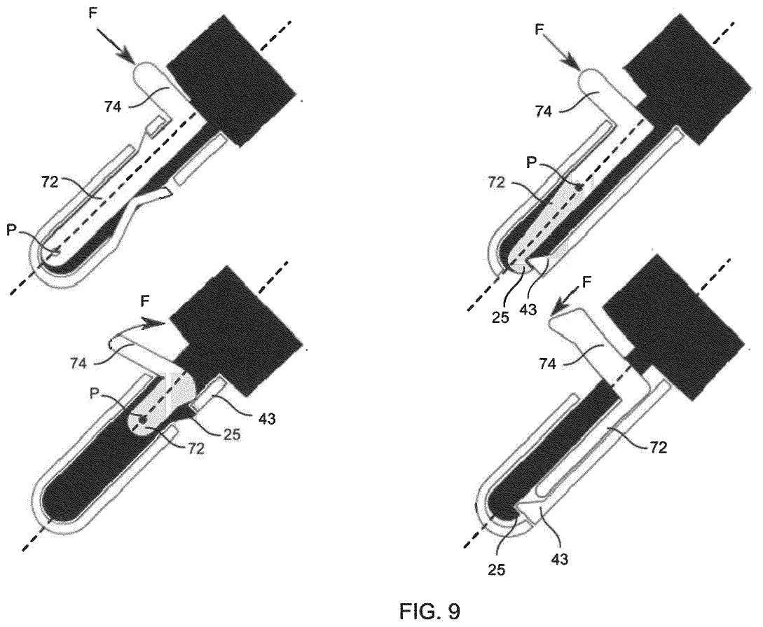

Two exemplary L-shaped release members (release mechanisms) have been described above. FIGS. 9A to 9D shows other ways in which the L-shaped release member 70 can be implemented.

In FIG. 9A, the L-shaped release member is part of the handle connecting structure with the pivot axis P located at the free end of the leg 72. The securing element of the handle connecting structure is formed on the top of the leg 72, with the complementary securing element of the cartridge connecting structure formed as a hole or recess in the upper housing. The bottom of the housing has an upwardly projecting bump to provide an upward biasing force against the leg 72 of the L-shaped release member. The user presses down on the foot 74 to disengage the securing elements.

The L-shaped release member shown in FIG. 9B is similarly part of the handle connecting structure with the pivot axis P located at the free end of the leg 72. Here, the securing element 25 is not formed on the L-shaped release member but instead on the lower surface of the handle connecting structure. The complementary securing element of the cartridge connecting structure is formed as a hole or recess in the lower housing. The heel of the foot 74 (where the foot 74 joins the leg 72) bulges away from the connection axis. When the foot 74 is pulled backwards, the heel of the foot 74 pushes against the inner housing to disengage the securing elements.

In FIG. 9C, the L-shaped release member is once again part of the handle connecting structure, but the pivot axis P is located at the middle of the leg 72 and the securing element 25 is provided at the free end of the leg 72. The complementary securing element 43 of the cartridge connecting structure is formed as a hole or recess at the closed end of the housing. To disengage the securing elements, the user pushes down on the foot 74.

In FIG. 9D, the L-shaped release member can be part of the cartridge connecting structure or part of the handle connecting structure. It is slidable along the connection axis rather than pivotable. The securing element 25 of the handle connecting structure is provided at its front end, with the complementary securing element 43 of the cartridge connecting structure formed as a projection at the closed end of the housing. To disengage the securing elements, the user pushes the foot 74 forwards.

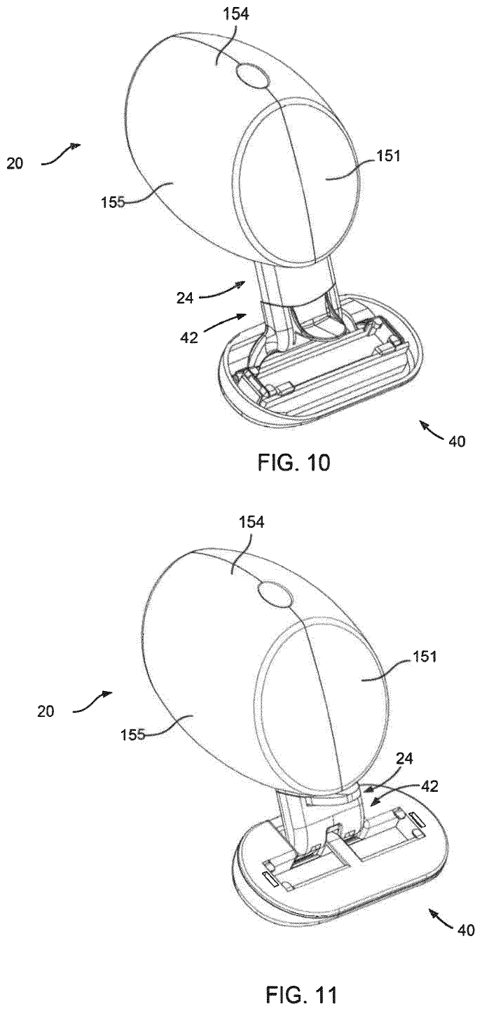

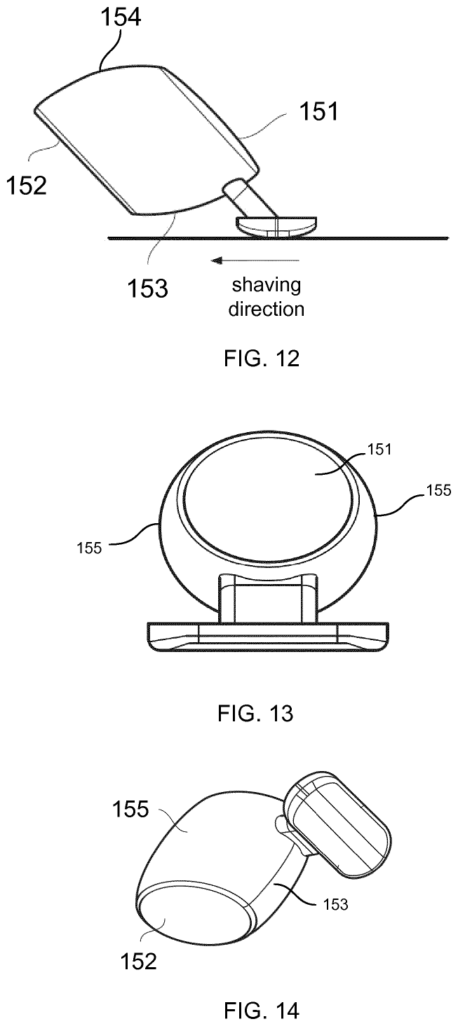

The handle depicted in FIGS. 1 to 9 is merely one of many different possible designs taken for illustration of the principle of the connecting structures. Indeed, a preferred handle that provides particularly flexible ergonomic handling (among other things) is shown in FIGS. 10 to 14. The connecting structures 24, 42 of the safety razor systems 10 shown in FIGS. 10 and 11 generally are the same as the connecting structures 24, 42 of the safety razor systems 10 shown in FIGS. 1 to 4 and FIGS. 5 to 8, respectively. They will therefore not be described again below.

The handle 20 of the safety razor system 10 shown in FIGS. 10 to 14 has a front surface portion 151, which is flat, a rear surface portion 152 which is also flat, a curved underneath surface portion 153 to which the handle connecting structure 24 is attached, a curved top surface portion 154 and curved side surface portions 155. These curved surface portions 155 together form a continuous smooth curved surface which is circular or spherical in cross section, but may vary in shape and size along its length between the front and rear of the handle. The handle 20 may be seen as a barrel-shape, for example, with slanted ends, or a similar ellipsoid barrel shape.

Similar to the terms “upper” and “lower” used previously, the terms “underneath” is used to describe features of the handle that are positioned on the skin-contacting side, and the term “top” is used to describe features of the handle that are positioned on a side opposite the underneath side. The terms “front”, “rear”, and “side(s)” are used herein with reference to the shaving direction, similar to the expressions “in front of” and “to the rear of” the blades used previously. In particular, the term “front” means facing the shaving direction, “rear” means facing away to the shaving direction, and “side(s)” mean to either side in the shaving direction. The term substantially cylindrical or substantially ellipsoid or substantially partially spherical surface is used to describe a shape which is close to cylindrical or ellipsoid or partially spherical form, for example with a 10% deviation from one of those forms. In one measure, a section (or all sections) taken vertically through the continuous smooth surface (for example in a direction parallel to the blade length) overlaps with a circle or ellipse drawn to just cover the whole section with the areas of the circle or ellipse which are not covered by the section being up to one tenth of the area of the section.

The handle connecting structure 24 can simply fit into a recess in the underneath surface portion 153, where it is glued or otherwise affixed in place. Of course, the handle connecting structure could alternatively be provided outside or inside the handle body via another structure that may be on (and/or inside) the side surface, or on (and/or inside) the flat end surface and the side surface.

While specific embodiments have been illustrated and described, it will be apparent to those skilled in the art that various changes and modifications may be made without departing from the invention. Accordingly, it is intended that the appended claims be interpreted as covering all such changes and modifications as fall within the true spirit and scope of the invention.

The Summary and Abstract sections may set forth one or more but not all exemplary embodiments of the present invention as contemplated by the inventor(s), and thus are not intended to limit the present invention and the appended claims in any way.

The breadth and scope of the present invention should not be limited by any of the above-described exemplary embodiments, but should be defined only in accordance with the following claims and their equivalents.

### REFERENCE LIST

10 safety razor shaving system

20 handle

24 handle connecting structure

25 securing element (of the handle connecting structure)

26 upper surface (of the handle connecting structure)

27 lower surface (of the handle connecting structure)

28 lateral surfaces (of the handle connecting structure)

29 front surface

30 cut-out portion of upper surface

32 cut-out portion of upper surface

40 replaceable razor cartridge

41 pivot arms

42 cartridge connecting structure

43 securing element (of the cartridge connecting structure)

44 guard

48 cap

50 lateral side portions (of the cartridge)

52 blade(s)

70 L-shaped release member

72 leg(s) (of L-shaped release member)

74 foot (of the L-shaped release member)

76 housing (of the cartridge connecting structure)

78 closed end (of the housing)

80 open end (of the housing)

82 pivoting structure

90 cavity (of the replaceable razor cartridge)

151 front surface portion (of handle)

152 rear surface portion (of handle)

153 underneath surface portion (of handle)

154 top surface portion (of handle)

155 side portion(s) (of handle)

1.-10. (canceled)

11. A safety razor shaving system, wherein the system comprises:
a handle comprising a handle connecting structure; and
a replaceable razor cartridge comprising a cartridge connecting structure;
the handle connecting structure and the cartridge connecting structure being configured to be brought together along a connection axis into a securely connected position; and
the handle connecting structure or the cartridge connecting structure comprising an L-shaped release member comprising a leg that extends along the connection axis and a foot that extends away from the connection axis, the L-shaped release member configured to release the handle connecting structure and the cartridge connecting structure from the securely connected position in response to a user-applied force to the foot.

12. The safety razor shaving system of claim 11, wherein the handle connecting structure and the cartridge connecting structure comprise complementary securing elements, one of which is formed on the leg of the L-shaped release member.

13. The safety razor shaving system of claim 11, wherein the L-shaped release member comprises a pair of the legs.

14. The safety razor shaving system of claim 11, wherein the handle connecting structure comprises the L-shaped release member.

15. The safety razor shaving system of claim 11, wherein the cartridge connecting structure comprises the L-shaped release member.

16. The safety razor shaving system of claim 11, wherein the L-shaped release member is configured to pivot about a pivot axis located at an intersection of the leg and the foot.

17. The safety razor shaving system of claim 11, wherein the L-shaped release member is configured to pivot about a pivot axis located at a free end of the leg.

18. The safety razor shaving system of claim 11, wherein the L-shaped release member is configured to pivot about a pivot axis located between a free end of the leg and an intersection of the leg and the foot.

19. The safety razor shaving system of claim 11, wherein the L-shaped release member is configured to be movable along the connection axis.

20. The safety razor shaving system of claim 11, wherein the L-shaped release member is integrally formed with a housing of the cartridge connecting structure, and the leg is configured to resiliently deform when the user-applied force is applied to the foot.

21. The safety razor shaving system of claim 11, wherein the cartridge connecting structure comprises a housing with a closed end and an open end, the open end configured to receive the handle connecting structure, at least a portion of the closed end located within a cavity of the replaceable razor cartridge.

22. The safety razor shaving system of claim 21, wherein the system further comprises a pivoting structure at the closed end of the housing, the pivoting structure located within the cavity of the replaceable razor cartridge and configured to allow the replaceable razor cartridge to pivot.

23. A replaceable razor cartridge for a safety razor shaving system comprising a handle comprising a handle connecting structure, the cartridge comprising:
a guard, a cap, and one or more blades disposed in parallel between the guard and the cap; and
a cartridge collecting structure configured to be brought together with the handle connecting structure along a connection axis into a securely connected position;
and the cartridge connecting structure comprising an L-shaped release member comprising a leg that extends along the connection axis and a foot that extends away from the connection axis, the L-shaped release member configured to release the handle connecting structure and the cartridge connecting structure from the securely connected position in response to a user-applied force to the foot.

24. A handle for a safety razor shaving system comprising a replaceable razor cartridge comprising a cartridge connecting structure, wherein the handle comprises:
a body configured to he gripped by a user; and
a handle connecting structure extending from the body, the handle connecting structure configured to be brought together with the cartridge connecting structure along a connection axis into a securely connected position;
and the handle connecting structure comprising an L-shaped release member comprising a leg that extends along the connection axis and a foot that extends away from the connection axis, the L-shaped release member configured to release the handle connecting structure and the cartridge connecting structure from the securely connected position in response to a user-applied force to the foot.
